(19) United States
(12) Patent Application Publication
(10) Pub. No.: US 2007/0126998 A1
(43) Pub. Date: Jun. 7, 2007

(54) Adding at least one picture to a contact detail in a communications device

(76) Inventor: Dee Nai Ong, Singapore (SG)

Correspondence Address: MOTOROLA INC, 600 NORTH US HIGHWAY 45, ROOM AS437, LIBERTYVILLE, IL, 60048-5343, US

(21) Appl. No.: 11/295,347

(22) Filed: Dec. 6, 2005

(51) Int. Cl. G03B 27/00

(52) U.S. Cl. 355/2

(57) ABSTRACT

A communications device (100) and method for adding at least one picture to a contact detail in a phone book (132) stored in the communications device is disclosed. The method includes storing (302) the at least one picture on the communications device during an audio visual communications call between the communications device and another device (202). The method further includes displaying an inquiry (404) on a display screen (106) of the communications device for identifying the at least one picture as possible data to be added to the contact detail in the phone book. The method further includes adding (312) the at least one picture to the contact detail in the phone book when a user interface (108) of the communications device provides an acceptance command in response to the inquiry.

### FIELD OF THE INVENTION

The present invention relates generally to a communications device and more specifically to adding at least one picture to a contact detail in the communications device.

### BACKGROUND

With the growth in modern technology communications devices such as mobile phones, pagers, personal digital assistants and the like, have been introduced in the market. These communications devices perform a wide variety of tasks and assist people in their daily activities. For example, these communications devices can be used to place telephone and audio visual calls, access the Internet, send and receive emails, and receive news updates. On receiving a request for establishing a communications connection, communications devices usually display a contact detail, typically a caller identifier that may match a name in the device's phone book, to thereby inform users of the source of the request. Some communications devices further display a stored picture, retrieved from the phone book, as part of the contact detail.

However, the communications devices described above suffer from the limitation that the there is no provision of adding a picture to the contact detail associated with another device that is the source of the request during or after the communications connection is established therebetween.

### BRIEF DESCRIPTION OF THE FIGURES

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic diagram illustrating a communications device, in accordance with various embodiments of the present invention;

FIG. 2 illustrates a communications connection between two communications devices, in accordance with various embodiments of the present invention; and

FIG. 3 illustrates a flowchart of a method for adding at least a picture to a contact detail in a phone book stored in the communications device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Various embodiments of the present invention provide a method for adding at least one picture to a contact detail in a phone book stored in a communications device. The method includes storing in the communication device at least one picture transmitted by another device during an audio visual communications call. The method further includes displaying an inquiry on a display screen of the communications device. The inquiry identifies the at least one picture as possible data to be added to the phone book. The method further includes responding to the inquiry using a user interface present in the communications device. In case the response is an acceptance the at least one picture is added to the contact detail in the phone book.

Various embodiments of the invention also provide a communications device comprising a processor, a memory module, a memory, a display screen and a user interface. The memory module stores a phone book. The memory is operatively coupled to the processor and stores at least one picture obtained from another device during an audio visual communications call. The processor displays an inquiry on the display screen identifying the at least one picture as possible data to be added to a contact detail in the phone book. A user can provide an acceptance command through the user interface. On receiving the acceptance command the processor adds the at least one picture to the contact detail in the phone book.

Before describing in detail embodiments that are in accordance with the present invention, it should be observed that the embodiments reside primarily in combinations of method steps and system components related to adding at least one picture to a contact detail in a phone book of a communications device. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “includes”, “including”, “comprising” or any other variation thereof, are intended to cover a non-exclusive inclusion, such that a process, method, article, system or system that includes a list of elements does not include only those elements but may include other elements not expressly listed or inherent to such process, method, article, system or system. An element proceeded by “includes . . . a” does not, without more constraints, preclude the existence of additional identical elements in the process, method, article, or system that comprises the element.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

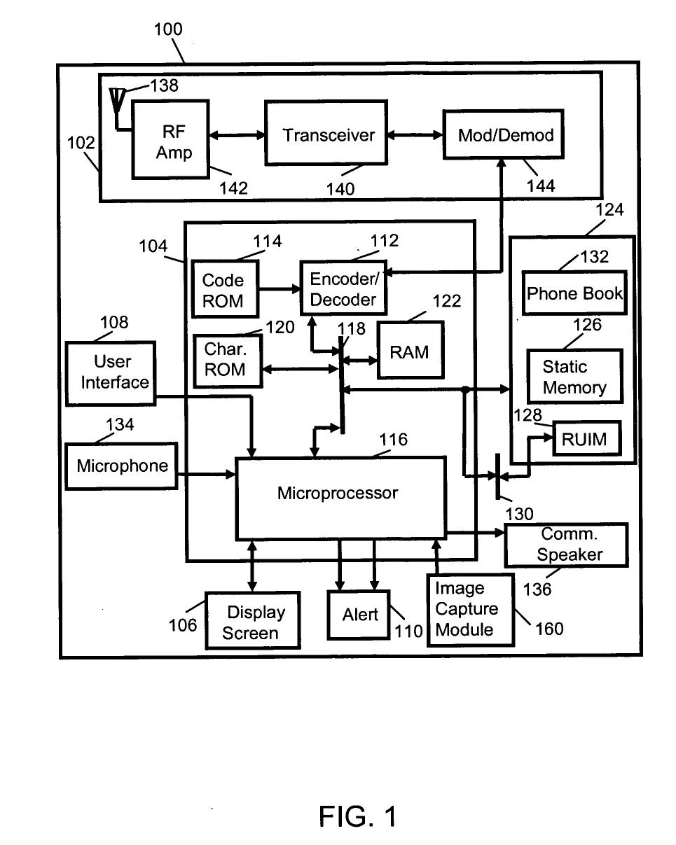

FIG. 1 is a schematic diagram illustrating a communications device 100, in accordance with various embodiments of the present invention. The communications device 100 is typically a wireless communications device. Examples of the wireless communications device include a mobile station or mobile telephone comprising a radio frequency communications unit 102 coupled with a processor 104 for communication. The communications device 100 also has an image capture module 160, a display screen 106 and a user interface 108. The image capture module 160 can be used for still image capture, video imaging capture or video conferencing where pictures and audio can be transmitted and/or received when the device 100 is communicating with another device having video conferencing capabilities. There is also an alert module 110 that typically contains an alert speaker, vibrator motor and associated drivers. The display screen 106, the user interface 108 and the alert module 110 are coupled with the processor 104 for communication.

The processor 104 includes an encoder/decoder 112 with an associated code Read Only Memory (ROM) 114 for storing data for encoding and decoding voice or other signals that may be transmitted or received by the communications device 100. The processor 104 also includes a micro-processor 116 coupled, by a common data and address bus 118, to the encoder/decoder 112, a character Read Only Memory (ROM) 120, a Random Access Memory (RAM) 122, a memory module 124 and a Removable User Identity Module (RUIM) interface 126. The memory module 124 includes a static programmable memory 128 and a RUIM card 130 (commonly referred to as a Subscriber Identity Module (SIM) card) operatively coupled to the RUIM interface 126. The memory module 124 can store, amongst other things, Preferred Roaming Lists (PRLs), subscriber authentication data, selected incoming text messages and a phone book 132, for example, a telephone number database, comprising a number field for telephone numbers and a name field for identifiers associated with one of the numbers in the name field. The RUIM card 130 and the static programmable memory 128 may also store passwords for allowing accessibility to password-protected functions on the communications device 100.

The micro-processor 116 has ports for coupling to the display screen 106, the user interface 108 and the alert module 110. Also, the micro-processor 116 has ports for coupling to a microphone 134 and a communications speaker 136 that are integral with the communications device 100.

The character Read Only Memory 120 stores code for decoding or encoding text messages that may be received by the radio frequency communications unit 102. In this embodiment the character Read Only Memory 120, the static programmable memory 128, and the RUIM card 130 may also store Operating Code (OC) for the micro-processor 116 and code for performing functions associated with the communications device 100.

The radio frequency communications unit 102 is a combined receiver and transmitter having a common antenna 138. The radio frequency communications unit 102 has a transceiver 140 coupled to the antenna 138 via a radio frequency amplifier 142. The transceiver 140 is also coupled to a combined modulator/demodulator 144 that couples the communications unit 102 to the processor 104.

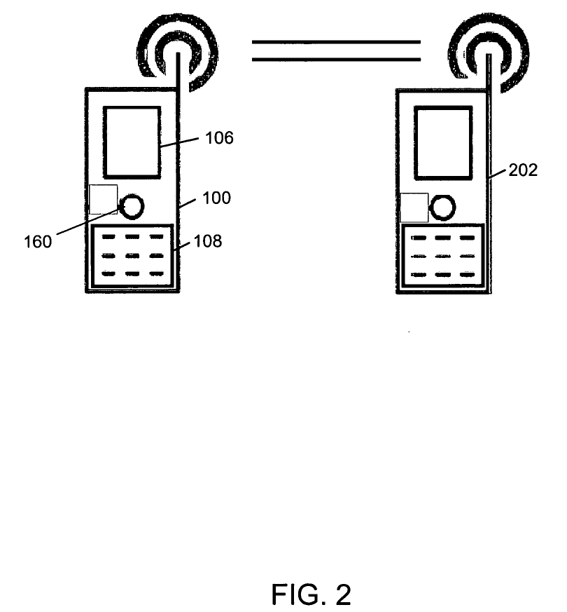

FIG. 2 illustrates an exemplary communications connection between two communications devices, in accordance with various embodiments of the present invention. The communications device 100 is in communication with another device 202, the another device 202 typically being a similar device to that of communications device 100. The radio frequency communications unit 102 can establish an audio visual communications call (video conference call) between the communications device 100 and the other device 202. The communications connection can be established through a communications network. Exemplary communications networks include Global System for Mobile Communications (GSM) networks, Code Division Multiple Access (CDMA) networks, Wireless Local Area Networks (WLANs), and the like. When the audio visual communications call is established, requested by the other device 202 (the calling party), a contact detail associated with the other device 202 is received by the communications device 100 and is displayed on the display screen 106. Examples of the contact detail include, but are not limited to, pictures, icons, a phone number associated with the other device 202 and phone number of a RUIM module of the other device 202. During an audio visual communications call, a video stream in the form of picture frames is transmitted from the other device 202 to the communications device 100 and vice versa. This video stream transmitted from device 202 is displayed on the display screen 106 of device 100 and a video stream obtained from image capture module 160 is transmitted to device 202. The video stream comprising video frames are progressively displayed to give the appearance of moving imagery that can include a plurality of pictures (frames) of a user of device 202. The plurality of pictures is stored (buffered) temporarily in the RAM 122. A user of the communications device 100 can thus add at least one of the plurality of pictures to the contact detail identifying the other device 202 in the phone book 132.

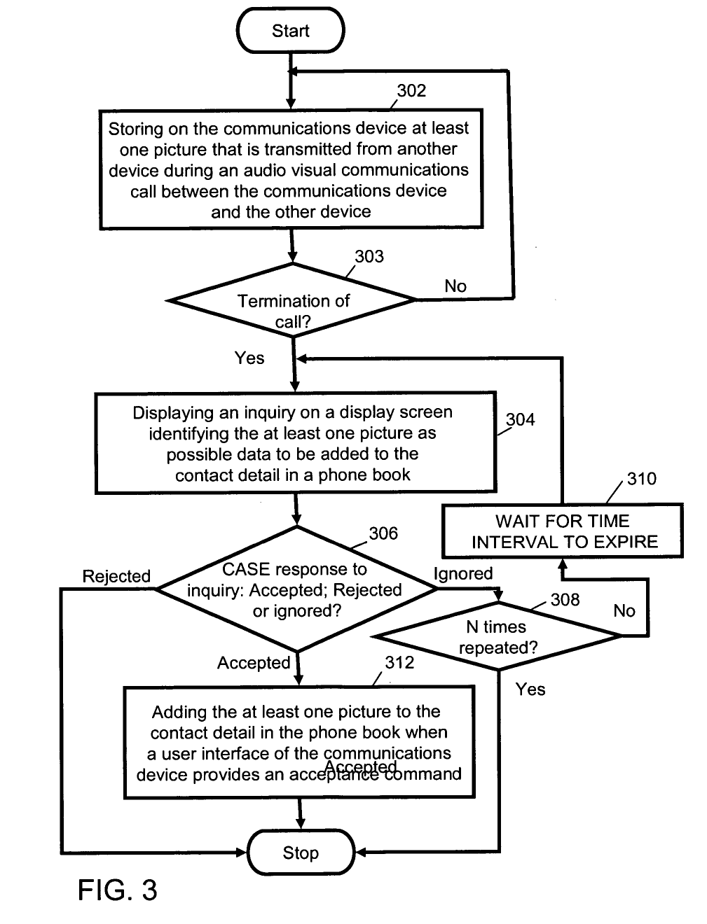

FIG. 3 illustrates a flowchart for adding at least one picture to a contact detail in the phone book 132 stored in the communications device 100, in accordance with an embodiment of the present invention. The at least one picture is a video frame transmitted from the other device 202 to the communications device 100 during an audio visual communications call. At step 302, the processor 104 stores at least one picture in the RAM 122, present in the communications device 100. The other device 202 is identified by the contact detail that is displayed on the display screen 106 when the audio visual communications call is established. Each of the plurality of pictures or video frames can be stored in response to a user command entered at the user interface 108 of the communications device 100, this command can be in response to the device 100 determining that the phone book 132 contact detail identifying the other device 202 does not include a picture or moving image (video content). The plurality of pictures can also be stored when the processor 104 detects a face in the video that is received during the audio visual communications call. A test in conducted at a step 303 to determine if the communications call is terminated, if the call is not terminated then step 302 is repeated. Once the communications call is terminated then, at step 304, the processor 104 displays an inquiry related to adding the at least one picture on the display screen 106 of the communications device 100. The inquiry identifies the at least one picture transmitted from the other device 202 as possible data to be added to the phone book 132 of the communications device 100. The inquiry can be displayed when the contact detail identifying the other device 202 is absent from the phone book 132. Therefore, the user of communications device 100 can also store contact information regarding the other device 202 along with the at least one picture, in case it is the first time that a communications connection has been established with the other device 202. The inquiry can also be displayed when the contact detail identifying the other device 202 is stored in the phone book 132, but there is no picture stored associated with the contact detail. The inquiry can be displayed as a dialog window on the display screen 106 of the communications device 100 to prompt or to remind user of the communications device 100 for adding the at least one picture, that may form part of a video frame sequence, to the contact detail in the phone book 132 of the communications device 100. In another embodiment, the dialog window can also display more than one of the pictures, or captured video frames stored at different time intervals during the audio visual communications call between the communications device 100 and the other device 202.

At a test step 306, the user's response to the inquiry is determined. In the case of an acceptance command, the at least one picture that can include a sequence of video frames representing a video or moving image are added to the contact detail, associated with other device 202 (e.g. details associated with a RUIM coupled to device 202), in the phone book 132 at step 312. Alternatively, in the case of the inquiry is rejected in the form of a rejection command the method terminates without the at least one picture However, in the absence of an acceptance or rejection response to the inquiry (after a pre-determine time) a test step 308 “N times repeated” determines if a reminder option has been set by the user. This option includes selecting the maximum number of times 'N” a reminder can be displayed and pre-determining time interval between reminders. If this option is not set then the method terminates without adding one or more of the pictures to the contact detail in the phone book 132. Alternatively, if the reminder option is set and the number of reminders N displayed at step 304 has not been reached then at step 310 the method waits for the pre-determined time interval before repeating the performing the displaying at step 304 and following test step 306.

Advantageously, the present invention allows for a plurality of pictures to be stored on the communications device 100 during the audio visual communications call between the communications device 100 and the other device 202. Each of the plurality of pictures can be stored in response to a user command entered at the user interface 108 of the communications device 100. The plurality of pictures can also be stored when the processor 104 detects a face in the video that is received during the audio visual communications call. Also, the pictures can be stored by selecting frames randomly or during time intervals (for instance every thousandth frame can be temporarily stored in RAM 122) After the termination of the communications connection between the communications device 100 and the other device 202, the plurality of pictures can be displayed on the display screen 106 of the communications device 100 for selecting and adding as possible data/detail to the contact detail. The processor 104 displays an inquiry as a dialog window for adding the plurality of pictures, on the display screen 106 of the communications device 100. The user of the communications device 100 can selectively add one or more of the plurality of pictures to the contact detail in the phone book of the communications device 100 with the help of the user interface 108. This can be done by, for example, scrolling to a picture using navigation keys, and selecting the picture using a capture key.

Various face detection techniques can be used for detecting whether a picture received from the other device 202 includes a face. Examples of face detection techniques include, but are not limited to, skin color segmentation, motion detection (for example, eye blinks), and neural networks based face detection. In a known skin color segmentation based face detection technique, the eyes and the mouth of a face are isolated using characteristic color properties of the eyes and the mouth. A triangle is then constructed using the eyes and the mouth. The face is identified as an oval region based on the triangle.

Various embodiments of the present invention, as described above, provide a communications device and method for adding at least one picture to a contact detail in a phone book stored in the communications device. When a communications connection is established between the communications device and another device, an inquiry is displayed to add the at least one picture to the contact detail associated with the other device. This makes the task of adding the at least one picture to the phone book of the communications device more user-friendly and easier. In case the user of the communications device is busy at the moment or forgets to respond to the inquiry at the first time, the inquiry is displayed again after a predetermined time interval. Further, the user of the communications device is capable of adding one or more of the plurality of the pictures stored during the audio visual communications call between the communications device and the other device.

It will be appreciated that embodiments of the invention described herein may be comprised of one or more conventional processors and unique stored program instructions that control the one or more processors to implement, in conjunction with certain non-processor circuits, some, most, or all of the functions of the communications device and method for adding at least one picture to a contact detail in the communications device described herein. The non-processor circuits may include, but are not limited to, a radio receiver, a radio transmitter, signal drivers, clock circuits, power source circuits, and user input devices. As such, these functions may be interpreted as steps of adding at least one picture to a contact detail in a communications device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A method for adding at least one picture to a contact detail in a phone book stored in a communications device, the method including:
storing on the communications device the at least one picture that is transmitted from another device during an audio visual communications call between the communications device and the other device, the other device being identified by the contact detail;
displaying an inquiry on a display screen of the communications device, the inquiry identifying the at least one picture as possible data to be added to the contact detail in the phone book; and
adding the at least one picture to the contact detail in the phone book when a user interface of the communications device provides an acceptance command in response to the enquiry.

2. A method as claimed in claim 1, wherein the displaying is performed after termination of the communications call.

3. A method according to claim 1, wherein the displaying is repeated at predetermined time intervals.

4. A method according to claim 1, wherein the displaying is repeated for a predetermined number of times.

5. A method according to claim 1, wherein the contact detail includes a phone number associated with the other device.

6. A method according to claim 1, wherein the contact detail includes a phone number of a removable user identity module (RUIM) of the other device.

7. A method according to claim 1, wherein the at least one picture is a video frame transmitted from another device during an audio visual communications connection.

8. A method according to claim 7 further comprising detecting whether the video frame comprises at least one face.

9. A method according to claim 1, wherein the storing is effected in response to a user command entered at a user interface of the communications device.

10. A method according to claim 1, wherein the at least one picture is selected from a plurality of pictures, each of the plurality of pictures being a video frame transmitted from the other device.

11. A method according to claim 10, wherein the displaying of the inquiry includes displaying the plurality of pictures.

12. A method according to claim 11, wherein the adding includes selectively adding one or more of the plurality of pictures.

13. A method according to claim 1, wherein the displaying is effected when the contact detail identifying the other device is absent from the phone book.

14. A method according to claim 1, wherein the displaying is effected when there is no picture included in the contact detail identifying the other device.

15. A method according to claim 1, wherein the adding is characterized by the at least one picture forms sequence of video frames that are added to the contact detail in the phone book.

16. A communications device including:
a processor;
a memory module storing a phone book;
a memory operatively coupled to the processor, wherein the processor stores at least one picture in the memory, the at least one picture being transmitted from another device to the communications device during an audio visual communications call between the communications device and the other device, the other device being identified by a contact detail;
a display screen operatively coupled to the processor, wherein the processor displays an inquiry on the display screen, the inquiry identifying the at least one picture as possible data to be added to the contact detail; and
a user interface operatively coupled to the processor and the display screen, the user interface providing an acceptance command, wherein on receiving the acceptance command, the processor adds the at least one picture to the contact detail.

17. A communications device according to claim 16, wherein the processor repeats the display of the inquiry at predetermined time intervals.

18. A communications device according to claim 16, wherein the processor repeats the display of the inquiry for a predetermined number of times.

19. A communications device according to claim 16, wherein the processor adds the at least one picture to provide sequence of video frames that are added to the contact detail in the phone book.
